(19) United States
(12) Patent Application Publication
(10) Pub. No.: US 2026/0177316 A1
(43) Pub. Date: Jun. 25, 2026

(54) APPARATUS FOR CONTINUOUS DRYING OF PARTICLES COMPRISING A CONTROL LOOP

(71) Applicant: Leon Crosset, Thimister (BE)

(72) Inventor: Leon Crosset, Thimister (BE)

(21) Appl. No.: 18/729,551

(22) PCT Filed: Jan. 23, 2023
(86) PCT No.: PCT/EP2023/051500

§ 371 Date: Jul. 17, 2024

(30) Foreign Application Priority Data
Jan. 26, 2022 (BE) BE20225049

(51) Int. Cl. F26B 17/00; F26B 3/06; F26B 25/22

(52) U.S. Cl. CPC F26B 17/005; F26B 3/06; F26B 25/22; F26B 2200/06; F26B 2200/08; F26B 2200/24

(57) ABSTRACT

A dryer for drying particles is provided that includes first and second circular plates mounted horizontally for rotation about an axis (Z), the surface of the plates being perforated and permeable to fluids, unit for blowing hot gas as a flow substantially parallel to the axis (Z) passing through the second plate before passing through the first plate, first and second units for distributing the particles and first and second units for recovering the particles after a rotation of each plate, a unit for transferring the harvested particles from the first plate (1a) to the second plate, a processor controlling the rotational speeds of the plates (ωa, ωb) and the supply flow rate (dma/dt) of particles on the basis of an output control loop. The output control loop being based a measurement of the final moisture content (H1b) of the particles measured in the second recovery unit.

### FIELD OF THE INVENTION

The invention relates to an industrial dryer for continuously drying particles, preferably organic particles, for example originating from the food processing industry, such as cereals, or waste used as a fuel or construction materials, such as woodchips or wood or other vegetable fibers. The dryer of the present invention makes it possible to dry particles, the initial humidity levels (H0a) of which may vary, to final humidity level values (H1b) lying in predefined target range (H1t±ε) constantly and reproducibly. This result is obtained by a first exit control loop, which measures the final exit humidity values (H1b) of the particles and modifies a series of operating parameters of the dryer, comprising the speeds of rotation (ωa, ωb) of the first and second plates as well as the rate of supply (dma/dt) of the particles onto the first plate (1a), so as to determine the values of these parameters that make it possible to dry the particles to contents lying in the target range (H1t±ε). The exit control loop may be supplemented with an entry control loop, which measures the initial humidity values (H0a) of the particles and modifies only the rate of supply (dma/dt) as a function of variations in these initial humidity values (H0a), without modifying the speeds of rotation (ωa, ωb) of the first and second plates, so as to keep the values of the final humidity level (H1b) of the particles in the reference target range (H1t±ε) independently of the variations of the initial humidity levels (H0a) of the particles to be dried.

### TECHNOLOGICAL BACKGROUND

Many industrial processes require particles to be dried before they are subsequently used, whether before packaging granular food industry products or industrial products, or before burning comminuted waste used as fuel. Depending on the type of use intended, the particles need to be dried so as to reach final humidity levels lying in well-defined target ranges (H1t±ε). For example, woodchips will need to be dried in different target ranges depending on whether they are intended for burning, for producing pellets, for producing litters or for producing chipboards. It is of course possible to dry the particles in batches by depositing the particles on plates, which are preferably perforated in order to allow a hot gas to be passed through and to let the water and water vapor escape. In certain cases, a fluidized bed is formed by the particles in suspension under the action of the hot gas flow. Most industrial applications, however, require throughputs that a batch drying process cannot achieve. For this reason, the same principle of depositing the particles to be dried on a perforated support and exposing them to a hot gas flow has been applied to devices that allow continuous drying, with a continuous source of the particles to be dried upstream of the dryer per se and continuous discharge of the dried particles downstream of the latter.

In particular, a belt dryer comprises a continuous flexible perforated belt tensioned between two motorized rollers, forming a loop. Hot air or another hot gas is blown under the upper cloth, on which the particles to be dried are continuously deposited. The length of a belt dryer depends on the type of particles to be dried, their water content and the target range (H1t±ε) to be achieved. A belt may thus have a length of as much as 200 m, which is very expensive and difficult to install on/remove from the device. A belt dryer is therefore generally reserved for drying a single type of particles, because it would be uneconomical to change the belt in order to optimize the type of perforation for a new type of particles. A belt dryer is very costly and relatively inefficient in terms of size since the particles are dried only over less than half of the length of the belt.

There are also dryers with perforated plates, which resemble belt dryers except that the belt is replaced with perforated plates coupled to one another, forming a kind of caterpillar. The difference from a belt dryer is that the plates are articulated so as to present the same face whether they are on the upper or lower band of the loop. This makes it practically possible to reduce the length of the dryer by half since the particles are subjected to a hot gas flow two times: once when they pass over the upper part of the loop and a second time when they pass in the opposite direction over the lower part. Although advantageous compared to a belt dryer from this point of view, it is clear that the mechanism required for the movements of the plates is complicated and therefore costly and fragile, especially when exposed to fine particles that jam the rolling bearings. Furthermore, the openings created between two adjacent plates, and especially the spaces that open up in the transfer mechanism of the plates each time a plate is transferred from the upper portion to the lower portion of the caterpillar, create a commensurate number of preferential paths of least resistance for the hot gas flow, which entail a significant efficiency loss of dryers of this type.

EP2503272 describes a dryer comprising a tube provided with plates in the form of circular segments distributed along the length of the tube, with openings that make it possible to pass from one plate to the next plate along the tube. The tube is contained in a cylindrical enclosure mounted so as to rotate relative to the tube. The lower surface of the tube comprises transfer elements, which sweep the upper surface of the plates (3) when the cylindrical enclosure rotates relative to the tube. The speed of rotation of the cylindrical enclosure is adjusted while observing the drying progress of the material being dried by measuring its humidity factor and its temperature.

EP0197171 describes a dryer comprising a plurality of circular perforated plates, which are stacked and mounted so as to rotate on a hollow central axle. Each plate is contained in an individual cylindrical chamber provided with a roof and a floor, which separate it from the other plates. Means for transferring the powder to be dried are provided between each adjacent plate. Each chamber is provided on the one hand with a first opening for introducing hot air, which is in fluidic communication with the cavity of the hollow central axle, the first opening being positioned above the plate that lies in the corresponding chamber and, on the other hand, a second opening for removal on the peripheral wall of the chamber, in communication with the exterior, the second opening being located below the corresponding plate. Hot air is blown into the cavity of the hollow axle and is distributed in parallel in each chamber via the first opening for introducing hot air. The hot air is compelled to pass through the circular perforated plate before it is removed via the second opening located on the peripheral wall of each chamber. Such a system is actually similar in principle to a belt dryer whose linear movement has been replaced with a circular movement distributed over a plurality of stages, with means for transferring the powder from one plate to the other. Although such a rotary system has a significant advantage of saving space on the ground in comparison with a linear belt dryer, such a system lacks efficiency. This is because although the hot air that has passed through the first plates loaded with very humid particles emerges relatively saturated in humidity, the hot air passing through the last plates loaded with particles already partially dried on the preceding plates will emerge loaded only little with humidity, which represents a considerable waste of energy.

EP2828595 describes a dryer, which is illustrated in FIG. 1, comprising a first and a second (or more) perforated plates (1a, 1b), which are stacked and are mounted so as to rotate about a vertical axis (Z). A ventilation system blows a hot gas vertically, passing first through the second plate (1b) before passing directly through the first plate (1a). Since it is a dryer, after having been passed through the second plate (1b) then the first plate (1a), the hot gas either is removed or is recirculated, but only on the condition that it has been dried and reheated before it is reinjected through the second plate.

The humid particles are distributed along a radius of the first plate (1a) by a first distribution unit (2a), and are carried by the rotation of the first plate over an angular (or azimuthal) distance of a little less than 360° before they are collected by a first recovery unit (3a). During the rotation of the first plate (1a), the particles are exposed to the hot gas stream that previously passed through the second plate, where it lost some of its calorific energy and became loaded with some humidity. The partially dried particles are transferred from the first recovery unit to a second system (3a) for distribution (2b), which distributes the partially dried particles along a radius of the second plate (1b), which rotates about the vertical axis (Z) in the opposite sense to the first plate (1a). The partially dried particles are carried by the rotation of the second plate (1b) (in the opposite sense to the first plate) over an angular (or azimuthal) distance of a little less than 360° before they are collected by a second recovery unit (3b) and removed. During the rotation of the second plate (1b), the particles are exposed to the hot gas stream directly from the ventilation system, where the hot gas has its maximum temperature and its minimum humidity level.

As can be seen in FIG. 1, since the plates rotate in opposite senses, the hot gas that reaches the particles just after they have been deposited along the radius of the first plate, where they have their maximum humidity level (H0a/H0a=100%), has the highest temperature and the lowest humidity level of all the hot gas that reaches the first plate, because it has previously passed through the practically dry particles (final humidity level H1b) just before they are removed with a humidity level that may be of the order of (by way of example) H1b/H0a=12%, where H0a is the initial humidity level of the particles at the entry of the first plate (1a) and H1b is the final level of the particles at the exit of the second plate (1b).

The dryer described in EP2828595 is particularly efficient in terms of energy, use and occupation of space on the ground. In a steady state, with particles having a relatively constant initial humidity level (H0a), the dryer ensures that the final humidity level (H1b) will constantly lie in the target range (H1t±ε). However, determining the operating parameters of the dryer that are necessary in order to reach the steady operating state may take time. Under certain conditions, furthermore, the initial humidity level (H0a) may vary considerably within a given batch of particles. Especially in the event that the particles are stored in the open air, and even exposed to bad weather and picked up with the aid of a mechanical scoop, which may at one time take off the top of the pile of particles and at another time scrape the ground at the place where a pool of water has been formed. If the initial humidity levels (H0a) of the particles vary by more than a tolerance (±δ) around a reference average value (H0r) (i.e., H0a/H0r±δ), it then becomes very difficult or even impossible to ensure that the particles after drying have a final humidity level (H1b) lying in the target range (H1t±ε), (i.e., if H0a≠H0r±δ=>H1b≠H1t±ε).

There is therefore still a need for an industrial dryer for drying particles continuously, which is efficient, easy to maintain and makes it possible to ensure drying of the particles to a final humidity level (H1b) lying in the target range (H1t±ε), independently of the type of particles to be dried and the variations of the initial humidity level (H0a) of the particles. The present invention provides such an industrial dryer.

### SUMMARY OF THE INVENTION

The present invention is defined in the independent claims. Preferred variants are defined in the dependent claims. In particular, the present invention concerns a dryer for drying particles having an initial humidity level (H0a) until reaching a final humidity level (H1b) that lies in a predefined target range centered around a target humidity value (H1t) (i.e., H1b=H1t±ε), the dryer comprising,
(a) an enclosure comprising an essentially cylindrical wall extending along a vertical axis (Z)
(b) a first circular plate mounted on the wall of said enclosure, substantially perpendicularly to the vertical axis (Z) and so as to rotate in a first sense about the vertical axis (Z), the rotation of which is actuated by a first motor, the surface of the first plate being perforated and permeable to fluids such as air, water vapor and water, and
(c) a second circular plate mounted at a certain distance from the first plate on the wall of said enclosure, substantially perpendicularly to the vertical axis (Z) and so as to rotate about said vertical axis (Z), the rotation of which is actuated by a second motor (5b), the surface of the second plate being perforated and permeable to fluids such as air, water vapor and water.

The first and second plates are configured, on the one hand, to support the particles to be dried and, on the other hand, to allow a hot gas blowing substantially parallel to the vertical axis (Z) to pass through them. In one preferred variant, the first plate is located below the second plate and the hot gas circulates from the top downward, and is preferably hot air. In all cases, it is preferred for the second plate to rotate in an opposite sense of rotation to the first plate. The dryer furthermore comprises:
(d) a first distribution unit for distributing the particles to be dried, which is configured to receive the particles to be dried from a supply unit and to distribute these particles before drying along a radius of the first plate,
(e) a first recovery unit, which is configured to recover the particles deposited on the first plate after a rotation of the latter through a given angle, the first recovery unit being located downstream of, and preferably adjacent to, the first distribution unit,
(f) a transfer unit for transferring the particles gathered from the first plate by the first recovery unit to a second distribution unit, which is configured to distribute said particles along a radius of the second plate,
(g) a second recovery unit for recovering the particles deposited on the second plate after a rotation of the latter through a given angle, the second recovery unit being located downstream of, and preferably adjacent to, the second distribution unit (2b) and being configured to remove the particles from the dryer by a removal system after drying,
(h) a system for blowing hot gas in a flow substantially parallel to the vertical axis (Z), passing first through the perforated surface of the second plate before passing directly after through the perforated surface of the first plate. The hot gas is used to remove the humidity of the particles and thus dry them.

The present invention is distinguished in that the dryer comprises:
(i) an exit sensor, which is located at the second recovery unit or in the removal system and is configured to measure the final humidity level (H1b) of the particles in or leaving the second recovery unit,
(j) a processor, which is coupled to the exit sensor, to the first and second motors and to the supply unit and is configured to optimize the drying parameters in the following way:
   extracting the final humidity level values (H1b) of the particles that are measured by the exit sensor in the course of time and comparing them with the target humidity level (H1t),
   if the final humidity level values (H1b) do not lie in the predefined target range (H1t±ε), modifying the values of the speeds of rotation (ωa, ωb) of the first and second plates and, optionally, a rate of supply (dma/dt) of the particles by the supply unit, in order to obtain final humidity level values (H1b) lying in the predefined target range (H1t±ε).

In the event that the final humidity level values (H1b) are greater than the predefined target range (i.e., H1b>H1t+ε) , the processor may furthermore be configured to determine theoretical values of one or more of the speeds of rotation (ωa, ωb) and the rate of supply (dma/dt) that make it possible to obtain final humidity level values (H1b) lying in the predefined target range (H1t±ε), and to:
reduce the first speed of rotation (|ωa |) of the first plate r to the corresponding theoretical value,
reduce the second speed of rotation (|@b |) of the second plate to the corresponding theoretical value, for example proportionally to the first speed of rotation (ωa) of the first plate, and
optionally, to reduce the rate of supply (dma/dt) of particles distributed onto the first plate to the corresponding theoretical value.

In the event that the final humidity level values (H1b) are less than the predefined target range (i.e., H1b<H1t±ε), the processor may furthermore be configured to determine theoretical values of one or more of the speeds of rotation (ωa, ωb) and the rate of supply (dma/dt) of the particles onto the first plate that make it possible to obtain final humidity level values (H1b) lying in the predefined target range (H1t±ε), and to:
increase the first speed of rotation (|ωa |) of the first plate (1a) to the corresponding theoretical value,
increase the second speed of rotation (|b |) of the second plate (1b) to the corresponding theoretical value, for example proportionally to the first speed of rotation (ωa) of the first plate (1a), and
optionally, to increase the rate of supply (dma/dt) of particles distributed onto the first plate (1a) to the corresponding theoretical value.

In one preferred variant of the invention, the dryer also comprises an entry sensor, which is placed at the supply unit or at the first distribution unit and is configured to measure an initial humidity level (H0a) of the particles entering the first distribution unit. The processor is configured to optimize the drying parameters only during a period in which the initial humidity level (H0a) has an initial value that is substantially constant and does not vary by more than a predefined reference range (±δ) around a reference value (H0r) (i.e., H0a=H0r±δ).

In one preferred example of this variant, the supply unit is preferably coupled to a source of particles to be dried. The processor is preferably configured to attenuate or eliminate time variations of the final humidity level values (H1b) that are due to time variations of the initial humidity level values (H0a) of the particles to be dried, in the following way:
extracting the initial values of the initial humidity levels (H0a) that are measured by the entry sensor in the course of time and comparing whether the initial values continue to lie in the predefined reference range (±δ) around the reference value (H0r) (i.e., H0a =H0r±δ),
if the initial values do not lie in the predefined reference range (i.e., H0a≠H0r±δ), modifying the rate of supply (dma/dt) of the particles by the supply unit without modifying the speeds of rotation (ωa, @b) of the first and second plates, in order to obtain final humidity level values (H1b) lying in the target range (H1t±ε) even in the event that the initial values (H0a) do not lie in the predefined reference range (i.e., H0a≠H0r±δ),
if the initial values lie in the predefined reference range (i.e., H0a=H0r±δ), not modifying the drying parameters.

In the preferred example, if the initial values of the initial humidity levels (H0a) are less than the reference range (i.e., H0a<H0r−δ), the processor is configured to:
determine a theoretical value of the rate of supply (dma/dt) that makes it possible to increase a thickness of a layer of particles distributed by the first distribution unit onto the first plate, in order to ensure that an intermediate humidity level (H1a) of the particles adjacent to the first recovery unit lies in an intermediate range (i.e., H1a =H1i±γ), and
increase the rate of supply (dma/dt) of the supply unit to the theoretical value.

Conversely, if the initial values of the initial humidity levels (H0a) are greater than the reference range (i.e., H0a>H0r+δ), the processor is configured to:
determine a theoretical value of the rate of supply (dma/dt) that makes it possible to reduce a thickness of a layer of particles distributed by the first distribution unit onto the first plate, in order to ensure that an intermediate humidity level (H1a) of the particles adjacent to the first recovery unit (3a) lies in an intermediate range (i.e., H1a=H1i±γ), and
reduce the rate of supply (dma/dt) of the supply unit to the theoretical value.

The first and second plates preferably comprise a rigid self-supporting structure with a high permeability of the grating type, on which a filtering layer comprising openings with a size and density corresponding to the permeability desired according to the type and size of the particles to be dried is placed.

The first and second distribution units for distributing the particles to be dried onto the first and second plates, respectively, as well as the supply unit, may each comprise at least one Archimedes'screw extending along a radius of the first and second plates, respectively, said at least one Archimedes'screw being contained in an enclosure provided with one or more openings extending along said radius of the plates.

Similarly, the first and second recovery units may each comprise at least one Archimedes'screw extending along a radius of said plate, which is contained in an enclosure provided with one or more openings extending along the radius of the first plate, said openings being connected to a scraper or brush capable of gathering the particles conveyed by the rotation of the plate and directing them toward the Archimedes'screw.

After the gas has passed through the perforated surface of the first plate, the hot gas blowing system (5) may either:
be configured to remove the gas from the enclosure, or
comprise an air dryer for capturing the moisture present in the gas before reheating the gas thus dried and recirculating it through the second and first plates, respectively.

For this purpose, the dryer may comprise a substantially cylindrical hollow shaft (6), which is centered around the vertical axis (Z) and the wall of which extends at least from the first plate to the last plate and comprises one or more openings offering fluidic access to the interior of the shaft for the gas that has passed through the perforated surface of the first plate. The shaft may comprise either:
one or more openings toward the outside of the enclosure, making it possible to remove the gas from the enclosure, or
the dryer and one or more openings configured to recirculate the gas after it has passed through the dryer, in a flow substantially parallel to the axis Z, passing first through the perforated surface of the second plate before passing directly after through the perforated surface of the first plate.

In one preferred variant, the supply unit (9) is connected upstream to a source of said particles to be dried, preferably a silo, the particles preferably comprising sawmill wood waste, construction material wood waste, paper or cardboard waste, food industry products such as cereals, and may be in the form of powder, granulates, chips, pellets, cakes, or fragments generally not exceeding 10 cm in length.

### BRIEF DESCRIPTION OF THE FIGURES

For better understanding of the nature of the present invention, reference is made to the following figures, in which:

FIG. 1: illustrates a dryer according to EP2828595.

FIG. 2: illustrates a variant of a dryer according to the present invention, comprising an exit control loop provided with an exit sensor located at the second recovery unit and an entry control loop provided with an entry sensor placed at the supply unit.

FIG. 3: illustrates the exit control loop with the variations of the speeds of rotation (ωa, ωb) and of the speed of distribution of the particles (dma/dt) onto the first plate in response to final humidity level values (H1b) measured by the exit sensor.

FIG. 4: illustrates the entry control loop with the variations of the speed of distribution of the particles (dma/dt) onto the first plate in response to variations of the initial humidity level (H0a) measured by the entry sensor, making it possible to stabilize the final humidity level (H1b) of the particles.

FIGS. 5(a) & 5(b): illustrate an example of a distribution unit suitable for the present invention, (a) perspective view, (b) plan view.

FIGS. 6(a) & 6(b): illustrate an example of a recovery unit suitable for the present invention, (a) plan view, (b) cross section.

FIGS. 6(c) & 6(d): illustrate a second example of a recovery unit suitable for the present invention, (a) plan view, (b) cross section.

FIG. 7: illustrates a flowchart of the exit control loop, including the exit sensor for measuring the final humidity levels (H1b) at the exit of the dryer.

FIG. 8: illustrates the flowchart of FIG. 7, with an additional condition that, in order to activate the exit control loop, it is necessary to ensure that the initial humidity levels (H0a) of the particles loaded into the dryer are relatively constant (i.e., H0a=H0r±δ).

FIG. 9: illustrates the flowchart of FIG. 8, furthermore with the entry control loop including the measurement of the initial humidity level (H0a) of the particles.

### DETAILED DESCRIPTION OF PARTICULAR EMBODIMENTS

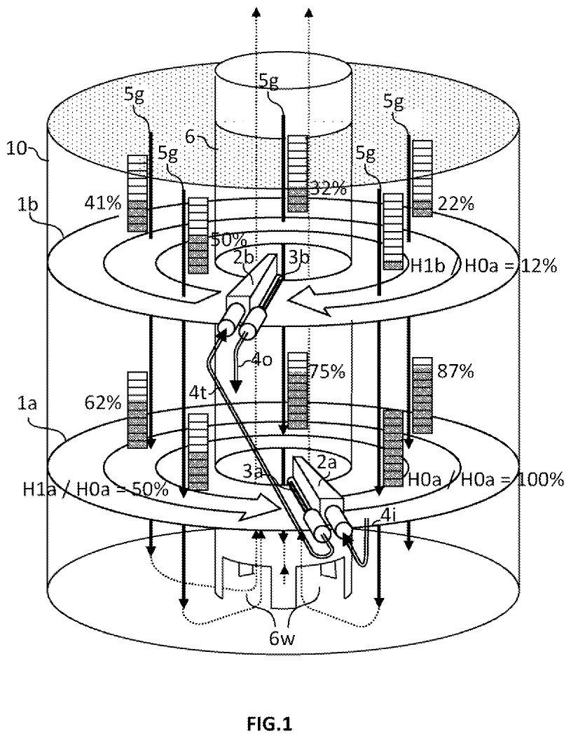

The dryer of the present invention is preferably a dryer of the type described in EP2828595, which is discussed in the section “Technological Background” above and is illustrated in FIG. 1. It is not essential for the first and second plates to rotate in opposite senses, although opposite rotations of the two plates are preferred because this increases the energy efficiency of the dryer.

The dryer of the present invention comprises an enclosure (10) comprising an essentially cylindrical wall extending along a vertical axis Z.

The enclosure contains a first circular plate (1a) mounted on the wall of the enclosure, substantially perpendicularly to the vertical axis Z. The first plate (1a) is mounted so as to rotate in a first sense about the vertical axis Z, its rotation being actuated by a first motor (5a). The surface of the first plate (1a) is perforated and permeable to fluids such as air, water vapor and water.

The enclosure (10) contains a second circular plate (1b) mounted at a certain distance from the first plate on the wall of the enclosure, substantially perpendicularly to the vertical axis Z. The second plate is mounted so as to rotate about the vertical axis (Z), its rotation being actuated by a second motor (5b). The second motor (5b) may be the first motor (5a) or may be a different motor than the first motor (5a). The rotation of the second plate may be in the same sense or in the opposite sense to the rotation of the first plate, and the speeds of rotation (|ωa |, |ωb |) of the first and second plates (as absolute values) may be equal or different, and may vary as a function of time, either independently of one another or, conversely, with the speed of rotation of one plate (=“master”) imposing the speed of rotation of the other plate (=“slave”). The surface of the second plate (1b) is perforated and permeable to fluids such as air, water vapor and water.

A first distribution unit (2a) for distributing the particles to be dried extends along a radius of the first plate (1a) and is configured to receive the particles to be dried from a supply unit (9) and to distribute these particles before drying along a radius of the first plate (1a). The supply unit makes it possible to control the rate of supply or loading (dma/dt) of the particles to be dried onto the first plate (1a).

A first recovery unit (3a) extends along a second radius of the first plate located downstream of, and preferably adjacent to, the first distribution unit (2a). The first recovery unit (3a) is configured to recover the particles deposited on the first plate (1a) after a rotation of the latter through a given angle. The angle of rotation is preferably at least equal to 300°, preferably at least equal to 320°, even more preferably at least equal to 340°, and preferably the largest angle that makes it possible to accommodate the first distribution unit (2a) and the first recovery unit (3a) along the respective radii of the first plate (1a). A large angle of rotation makes it possible to increase the time during which the particles are exposed to the hot gases for a given speed of rotation. An angle of practically 360° may be obtained by stacking the first distribution unit (2a) above the first recovery unit (3a).

The enclosure (10) also contains a transfer unit (4t) for transferring the particles gathered from the first plate (1a) by the first recovery unit (3a) to a second distribution unit (2b). The second distribution unit (2b) extends along a radius of the second plate (1b) and is configured to distribute the particles onto the second plate (1b), along the radius of the second plate. A second recovery unit (3b) for recovering the particles deposited on the second plate (1b) is located downstream of the second distribution unit (2b), preferably adjacent to the second distribution unit (2b), so that the particles reach it after a rotation of the plate through a given angle. The second recovery unit is configured to remove the particles from the dryer by a removal system (40) after drying.

The dryer comprises a hot air blowing system (5) configured to form a hot gas flow substantially parallel to the vertical axis (Z), passing first through the perforated surface of the second plate (1b) before passing directly after through the perforated surface of the first plate (1a). It is the hot, dry gas which, by making contact with the humid particles, will (a) raise their temperature and (b) take away some of their humidity. As a consequence of this, the temperature of the hot gas is lowered and its humidity level increases, first when it passes through the second plate (1b) and then a second time when it passes through the first plate (1a). The gas leaving the first plate therefore has a humidity level that is too high for it to be recirculated as it is. In practice, the gas cooled and humidified in this way is therefore either removed outside the enclosure into the atmosphere or for a different use, such as a heat exchanger or a humidifier (cf. dotted arrows in FIG. 1 removing the gases upward from the dryer through a shaft (6) of the dryer), or recirculated after drying and reheating. The blowing system may comprise a fan, or preferably a plurality of fans. The fan or fans may be configured to draw the hot gases in while creating a reduced pressure downstream of the plates. In this variant, the fan or fans are positioned downstream of the first plate (1a). In an alternative embodiment, the fan or fans may be configured to blow the hot gas while creating a positive pressure upstream of the second plate (1b). In this variant, the fan or fans are positioned upstream of the second plate (1b). The terms “upstream” and “downstream” used to define the blowing system are defined in relation to the direction of movement of the gas through the second plate (1b) before passing through the first plate (1a).

The dryer of the present invention is distinguished from the previous dryers in that it furthermore comprises an exit sensor (7), which is located at the second recovery unit (3b) or in the removal system (40) and is configured to measure the final humidity level (H1b) of the particles in or leaving the second recovery unit (3b). A processor (11) is coupled to the exit sensor (7), to the first and second motors (5a, 5b) and to the supply unit (9) and is configured to optimize the drying parameters in the following way:
extracting the final humidity level values (H1b) of the particles that are measured by the exit sensor (7) in the course of time and comparing them with the target humidity level (H1t),
if the final humidity level values (H1b) do not lie in the predefined target range (H1t±ε), modifying the values of the speeds of rotation (ωa, ωb) of the first and second plates (1a, 1b) and, optionally, a rate of supply (dma/dt) of the particles by the supply unit (9), in order to obtain final humidity level values (H1b) lying in the predefined target range (H1t±ε).

### Exit Control Loop Based on the Measurements by the Exit Sensor (7)

The dryer of the present invention is controlled by the processor (11) through a first control loop, referred to as the exit control loop. The exit control loop is based on the following principles.

For a constant thickness of a layer of particles, a slower speed of rotation of one of the plates increases the drying time of the particles on this plate and is therefore recommended in the event that the final humidity level values (H1b) of the particles that are measured by the exit sensor (7) are greater than the target humidity level (H1t) (i.e., the particles are still too humid). Conversely, a faster speed of rotation of one of the plates reduces the drying time of the particles and is recommended when the final humidity level values (H1b) of the particles that are measured by the exit sensor (7) are less than the target humidity level (H1t). If the particles are too dry or drier than is necessary or acceptable, this indicates that the dryer is wasting energy for no useful purpose.

Preferably, the processor (11) controls the speed of rotation of the second plate (1b), which acts as a “master”, while forcing the first plate (1a), which acts as a “slave”, to adapt its speed of rotation automatically to that of the second “master” plate (1b). The first plate (1a) adapts its speed automatically to that of the second plate (1b) by rotating at a speed proportional to that of the second plate (1b), which is the “master”. The coefficient of proportionality (ωa/ωb) between the speeds of rotation of the first plate (1a) and of the second plate (1b) is predefined, and is preferably negative (i.e., the first plate (1a) rotates in the opposite sense to the second plate (1b)). In one preferred variant, the absolute value of the coefficient of proportionality (ωa/ωb) is between 0.7 and 1.3, preferably between 0.8 and 1.05. Preferably, as absolute values, the speed of rotation of the first plate (1a) is equal to the speed of rotation of the second plate (1b). If the first plate (1a) rotates more rapidly than the second plate (i.e., |ωa/ωb |>1), the thickness of the layer of particles on the second plate (1b) is greater than that of the first plate (1a). Conversely, if |ωa/ωb |<1, the thickness of the layer of particles on the second plate (1b) is less than that of the first plate (1a). Consequently, if |ωa/ωb |=1, the thickness of the layer of particles on the second plate (1b) is substantially equal to that of the first plate (1a).

Lastly, for a constant speed of rotation of the first plate (1a), reducing the rate of supply (dma/dt) of the particles by the supply unit (9) has the effect of reducing the thickness of the layer of particles formed on the first plate (1a). The particles of the first plate are thus dried more rapidly by the hot gas flow. Such a reduction of the rate is therefore recommended when the final humidity level values (H1b) measured by the exit sensor (7) are greater than the target humidity level (H1t) (i.e., the particles are still too humid). Conversely, increasing the rate of supply (dma/dt) of the particles by the supply unit (9) has the effect of increasing the thickness of the layer of particles formed on the first plate (1a). A greater volume of particles of the first plate is thus dried by the hot air flow. Such an increase of the rate is therefore recommended when the final humidity level values (H1b) measured by the exit sensor (7) are less than the target humidity level (H1t) (i.e., the particles are still drier than is necessary).

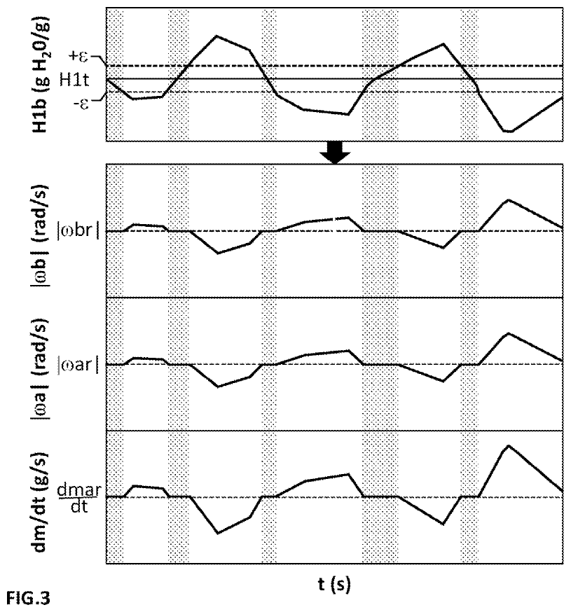

Taking into account the effects described above, the processor (11) is configured to control the speeds of rotation (ωa, ωb) of the first and second plates (1a, 1b) as well as the rate of supply (dma/dt) of the particles by the supply unit (9) in the following way, which is illustrated in FIGS. 3, 6 and 7. FIG. 3 schematically illustrates variations of the final humidity level (H1b) of the particles that is measured by the exit sensor (7). The target humidity level (H1t) and the predefined target range (H1t±ε) are represented by a continuous line centered between two dashed lines. Each time the measured final humidity level (H1b) departs from the predefined target range (H1t±ε), the processor (11) can vary one or all among the speeds of rotation (ωa, ωb) of the first and second plates (1a, 1b) and the rate of supply (dma/dt) so that the measured final humidity level (H1b) falls within the predefined target range (H1t±ε) . This makes it possible to define reference speeds (ωar, ωbr) of the first and second plates (1a, 1b) and a reference rate of supply (dmar/dt) that make it possible to dry the particles in the predefined target range (H1t±ε). FIG. 3 illustrates constant variations of the final humidity level (H1b) of the particles in order to illustrate the possible variations of parameters that the processor (11) can control. In reality, once a steady state has been found, the reference values (ωar, ωbr, dmar/dt) that make it possible to dry the particles in the predefined target range are saved and kept so long as a significant variation of the steady state does not occur.

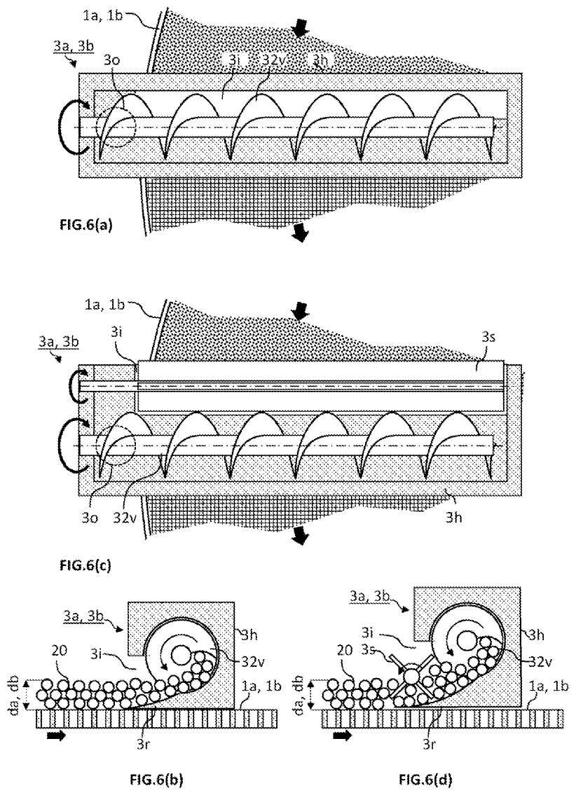

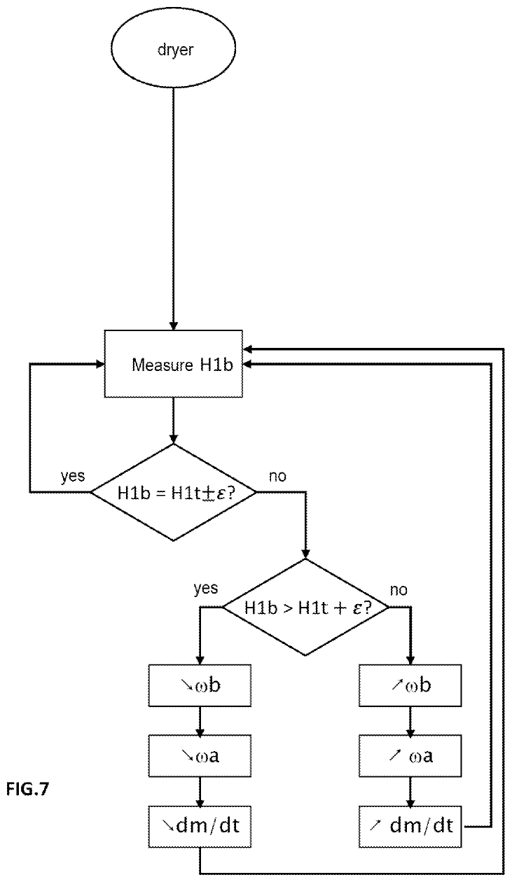

As illustrated in FIGS. 3 and 6 (and 7 and 8), the exit sensor (7) measures the final humidity level (H1b) of the particles. If H1b lies in the predefined target range (H1t±ε), the processor keeps the reference values (ωar, ωbr, dmar/dt) (cf. FIG. 3, shaded regions, and FIG. 7, “yes” branch of the rhombus rhombus [H1b=H1t±ε?]). If H1b departs from the predefined target range (H1t±ε) , on the other hand, the processor is configured to act in the following way.

In a first case, in which the final humidity level values (H1b) are greater than the predefined target range (i.e., H1b>H1t±ε), the processor (11) determines theoretical values of the speeds of rotation (ωa, ωb) of the first and second plates (1a, 1b) and/or of the rate of supply (dma/dt) that make it possible to obtain final humidity level values (H1b) lying in the target range. As illustrated in FIG. 3 (sections of curve (H1b) above the dashed line “+ε”) and 6 (“yes” branch of the rhombus [H1b>H1t±ε?)], the processor is then configured to
reduce the second speed of rotation (|ωb |) of the second plate (1b) to the corresponding theoretical value,
reduce the first speed of rotation (|ωa |) of the first plate (1a) to the corresponding theoretical value; preferably, the first plate is subordinate (=“slave”) to the second plate (1b) (=“master”) while automatically adapting its speed of rotation proportionally to that of the second plate, and/or
reduce the rate of supply (dma/dt) of particles distributed onto the first plate (1a) to the corresponding theoretical value.

In a second case, in which the final humidity level values (H1b) are less than the predefined target range (i.e., H1b<H1t−ε), the processor (11) determines theoretical values of the speeds of rotation (ωa, ωb) and of the rate of supply (dma/dt) of the particles onto the first plate (1a) that make it possible to obtain final humidity level values (H1b) lying in the predefined target range (H1t±ε). This allows (1) a given volume of particles to be dried to the predefined target range in less time and therefore less expensively. As illustrated in FIG. 3 (sections of curve (H1b) below the dashed line “−ε”) and 6 (“no” branch of the rhombus [H1b>H1t±ε?]), the processor is then configured to
increase the second speed of rotation (|ωb |) of the second plate (1b) to the corresponding theoretical value,
increase the first speed of rotation (|ωa |) of the first plate (1a) to the corresponding theoretical value, for example proportionally to the second speed of rotation (ωb) of the second plate (1b), and/or
increase the rate of supply (dma/dt) of particles distributed onto the first plate (1a) to the corresponding theoretical value.

### Entry Sensor (8)

The exit control loop based on the measurement by the exit sensor (7) described above makes it possible successfully to determine reference speeds of rotation (ωar, ωbr) of the plates (1a, 1b) and a reference rate of supply (dmar/dt) that make it possible to dry particles to a final humidity level (H1b) lying in the predefined target range on the condition that the initial humidity level (H0a) of the particles before drying is substantially constant, i.e., lies in a predefined reference range (±δ) around a reference average value (H0r) (i.e., H0a=H0r±δ).

If the initial humidity level (H0a) of the particles varies substantially (i.e., |dH0a/dt|>δ) in a time interval (t0), the exit sensor (7) will detect such a variation only after a delay (Δt) that is necessary so that the particles deposited on the first plate (1a) in the time interval (t0) can perform a rotation on the first plate (1a), be transferred onto the second plate (1b), and perform a rotation on the second plate until they reach the second recovery unit (3b) and the exit sensor (7). The processor (11) will be able to react to these humidity variations only after the delay (Δt), which is much too long, and which would be useless if the initial humidity level (H0a) of the particles has again varied substantially during this delay (i.e., if t0<Δt). It is therefore expedient to know the value of the initial humidity level (H0a) of the particles in the course of time.

In order to overcome this problem, in addition to the exit sensor (7) described above, one preferred variant of the dryer of the present invention also comprises an entry sensor (8) which is placed at the supply unit (9) or at the first distribution unit (2a). The entry sensor (8) is configured to measure an initial humidity level (H0a) of the particles entering or contained in the first distribution unit (2a).

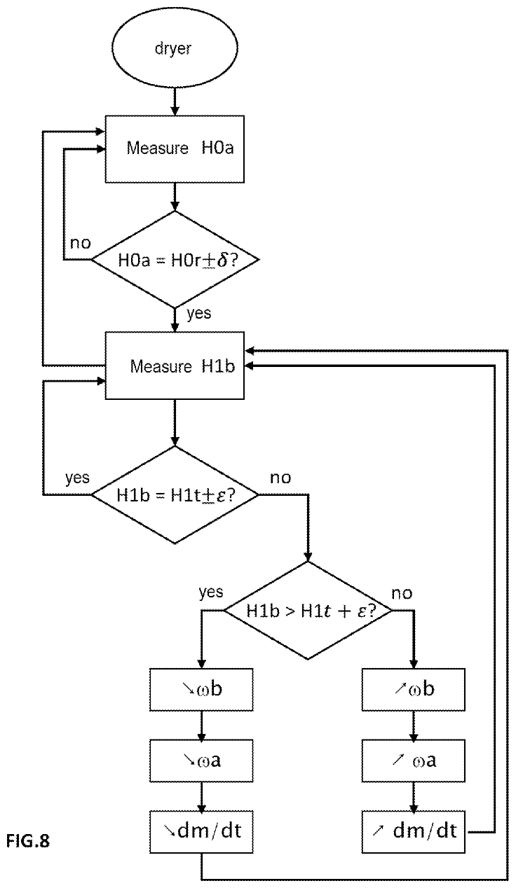

In one preferred variant, which is illustrated in FIG. 8, the processor is configured to optimize the drying parameters on the basis of the values (H1b) measured by the exit sensor (7) only during a period in which the initial humidity level (H0a) has an initial value that is substantially constant and does not vary by more than the predefined reference range (±δ) around the reference average value (H0r) (i.e., if |dH0a/dt|≤δ, or if H0a=H0r±δ) (cf. FIG. 8, rhombus [H0a/H0r±δ]).

By this configuration, the processor can determine the optimum reference values of the speeds of rotation (ωar, ωbr) of the plates (1a, 1b) and of the rate of supply (dmar/dt) in order to dry the particles in the desired range during steady-state operation, i.e., when the initial humidity level (H0a) of the particles remains substantially constant during the drying process. If the particles to be dried in a given batch have initial humidity levels (H0a) that vary substantially from one region of the batch to another, a person skilled in the art is offered two solutions. A first option comprises a step of mixing the particles before the drying in order to homogenize the initial humidity level (H0a) of the particles. A second option, which the dryer of the present invention makes it possible to implement, is to vary the thickness of the layer of particles that are deposited on the first plate (1a) as a function of the variations of the initial humidity level (H0a) of the particles. For this purpose, the processor (11) may comprise a second control loop, referred to as the entry control loop, which is based on the measurements by the entry sensor (8).

### Entry Control Loop Based on the Measurements by the Entry Sensor (δ)

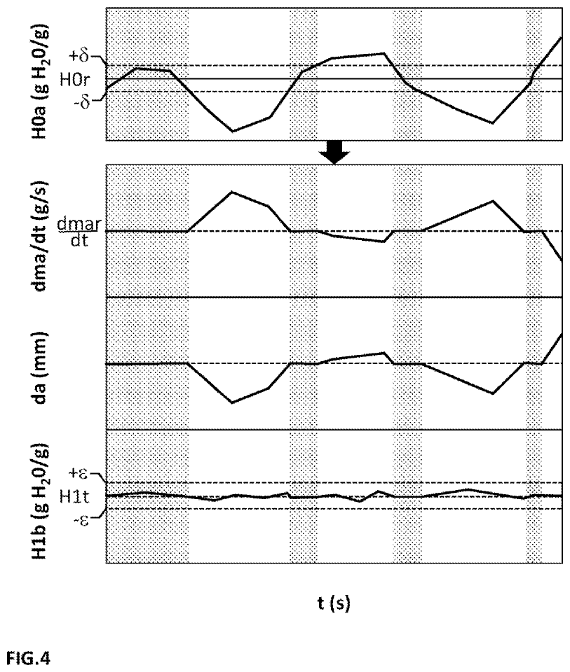

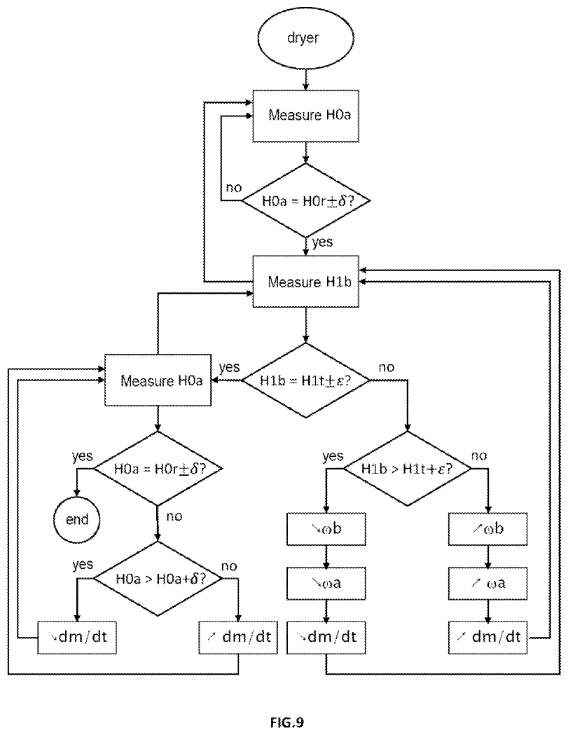

As indicated above, in one preferred variant of the dryer of the present invention, the processor (11) comprises an entry control loop which is based on the measurements by the entry sensor (8). FIG. 9 is similar to FIG. 8, with in addition the entry control loop described in the present section. In this variant, the supply unit (9) is coupled to a source (20) of particles to be dried and the processor (11) is configured to attenuate or eliminate time variations (dH1b/dt) of the final humidity level values (H1b) due to time variations (dH0a/dt) of the initial humidity level values (H0a) of the particles to be dried. As illustrated in FIGS. 4 and 8, the processor (11) is therefore configured to extract the initial values of the initial humidity levels (H0a) measured by the entry sensor (8) in the course of time, and to compare whether the initial values continue to lie in the predefined reference range (±δ) around the reference average value (H0r) (i.e., if |dH0a/dt|≤δ, or if H0a=H0r±δ) (cf. FIG. 9, “yes” branch of the rhombus [H1b=H1t±ε?] followed by the rhombus [H0a=H0r±ε?]).

If the initial values do not lie in the predefined reference range (i.e., if |dH0a/dt|>δ or, equivalently, if H0a≠H0r±δ), the processor is configured to modify the rate of supply (dma/dt) of the particles by the supply unit (9) without modifying the reference speeds of rotation (ωar, ωbr) of the first and second plates (1a, 1b), in order to modify as a function of time the thickness of the layer of particles that are deposited on the first plate (1a) and thus modify an intermediate humidity level (H1a) of the particles at the exit of the first plate (1a) before they are transferred onto the second plate (cf. FIG. 4, graph “dma/dt” in response to the variations of the measured initial humidity level (H0a), and graphs “da” and “H1b” illustrating the consequences of the variations of dma/dt on the thickness (da) of the layer of particles on the first plate (1a) and finally on the value of the final humidity level (H1b), which is thus kept within the predefined target range.

It is clear that if the average value of the thickness of the layer deposited on the first plate (1a) varies from one revolution to another, the thickness of the layer formed on the second plate (1b) by the particles transferred from the first plate (1a) will vary according to these variations. In contrast to the first plate (1a), however, on which the thickness of the layer of particles may vary from one angular sector of the first plate (1a) to another, the thickness of the layer of particles on the second plate (1b) is substantially constant. This is because the transfer unit (4t) mixes and homogenizes the mass of particles gathered by the first recovery unit (3a) and deposits the particles on the second plate (1b) at a constant rate, thus forming a layer with a substantially constant thickness on the second plate (1b).

By virtue of the entry control loop, it is possible to obtain final humidity level values (H1b) lying in the target range (H1t±ε) even in the event that the initial values (H0a) vary substantially over the time of distribution onto the first plate (1a). With this entry control loop, the thickness of the layer of particles deposited on the first plate (1a) can vary with the azimuthal angle, thus making it possible to respond almost instantaneously to the variations (dH0a/dt) of the initial humidity values (H0a) over the distribution time. This makes it possible to obtain a substantially constant intermediate humidity level (H1a) of the particles at the exit of the first plate (1a) after a revolution of the first plate (1a) before they are transferred onto the second plate (1b), independently of the variations of initial humidity levels (H0a) of the particles in the first distribution unit (2a).

The entry control loop based on the entry sensor (8) is subordinated to the loop based on the exit sensor (7). The exit control loop based on the exit sensor (7) defines the basic operating parameters of the dryer, including the speeds of rotation (ωa, ωb) of the first and second plates (1a, 1b) and the rate of supply (dma/dt) for a given batch of particles. These basic parameters may remain constant so long as the properties of the batch of particles to be dried, such as the initial humidity level (H0a), size and distribution of sizes of the particles, etc., are substantially constant. The exit control loop is therefore long-term control, while the entry control loop is instantaneous control based on the short term.

Specifically, the entry control loop based on the entry sensor (8) makes it possible to adapt these parameters to the instantaneous variations of the initial humidity level (H0a) of the particles in this batch. The entry control loop makes it possible to react very rapidly to variations of the initial humidity level (H0a) of the particles by controlling the rate of supply (dma/dt) according to the initial humidity level (H0a) measured by the entry sensor (8).

In particular, if the initial values of the initial humidity levels (H0a) are less than the reference range (i.e., H0a<H0r−δ), the processor (11) determines a theoretical value of the rate of supply (dma/dt) that makes it possible to increase the thickness of the layer of particles distributed by the first distribution unit (2a) onto the first plate (1a). This makes it possible to ensure that the intermediate humidity level (H1a) of the particles adjacent to the first recovery unit (3a) lies in an intermediate range (i.e., H1a=H1i±γ). The processor (11) then increases the rate of supply (dma/dt) of the supply unit to the theoretical value.

Conversely, if the initial values of the initial humidity levels (H0a) are greater than the reference range (i.e., H0a>H0r±δ), the processor (11) determines a theoretical value of the rate of supply (dma/dt) that makes it possible to reduce the thickness of the layer of particles distributed by the first distribution unit (2a) onto the first plate (1a). This makes it possible to ensure that the intermediate humidity level (H1a) of the particles adjacent to the first recovery unit (3a) lies in the intermediate range (i.e., H1a=H1i±γ). The processor then reduces the rate of supply (dma/dt) of the supply unit to the theoretical value.

In its determination of the theoretical value of the rate of supply (dma/dt) that makes it possible to vary the thickness of the layer of particles on the first plate (1a) in order to keep the final humidity levels (H1b) in the predefined target range (i.e., H1b=H1t±ε), with the first and second plates (1a, 1b) rotating at their respective reference speeds (ωar, ωbr) that are determined with the exit control loop, the processor (11) takes into account the first speed of rotation (ωa) of the first plate (1a) and determines the thickness of the layer of particles that makes it possible to obtain a substantially constant intermediate humidity level (H1a) of the particles at the exit of the first plate (1a), before they are transferred onto the second plate.

If the values of the initial humidity levels (H0a) of the particles vary to such an extent that the reference average value also varies, then although varying the rate of supply (dma/dt) of the particles onto the first plate (1a) will make it possible to obtain a constant value of the intermediate and final humidity levels (H1a, H1b), it is however possible that the value of the final humidity level (H1b) will depart from the predefined target range (H1t±ε). For this reason, the exit control loop continues to measure the final humidity level (H1b) of the particles and, if this value departs from the predefined target range, the controller (11) can determine a new value of the reference speeds (ωar, ωbr) of the first and second plates (1a, 1b) making it possible to return the final humidity level (H1b) into the predefined target range (H1t±ε) (cf. FIG. 9, loop [measure H1b]−[measure H0a]).

### Structure of the Dryer-Supply Unit (9)

The supply unit (9) is coupled upstream to a source (20) of particles to be dried, for example stored in a silo, a container, a truck, etc., and downstream to the first distribution unit (2a). The supply unit (9) preferably makes it possible to control precisely and vary the rate of supply of particles to the first distribution unit (2a) in order to be able to vary the thickness (da) of the layer of particles deposited on the first plate by the first distribution unit (2a) in response to the exit and/or entry control loop.

Any supply unit enabling such control, which is known to a person skilled in the art, may be used, and the present invention is not limited to a particular type or model of supply unit. For example, the supply unit (9) may comprise one or more Archimedes'screws, the speed of rotation of which controls the rate of supply (dma/dt) of the particles supplying the first distribution unit (2a). Alternatively, the supply unit may comprise a belt conveyor, the movement speed of which can be controlled in order to control the rate of supply (dma/dt).

### Structure of the Dryer—1^{st} and 2^{nd} Distribution Units (2a, 2b)

The supply unit (9) is coupled downstream to the first distribution unit (2a) and is configured to supply the first distribution unit (2a) at a rate of supply controlled by the processor. The first distribution unit (2a) for distributing the particles to be dried onto the first plate (1a) has the purpose of distributing the particles to be dried homogeneously along a radius of the first plate (1a). In general, the first distribution unit (2a) comprises:
a structure extending from the outer periphery to the inner periphery of a plate, preferably along a radius of the latter,
means for transporting the particles from the outer periphery to the inner periphery of the plates, and lastly
means for depositing said particles from the means of transport to the plates.

Several solutions are possible. For example, the transport of the particles from the outer periphery to the inner periphery of the plates may be performed by a conveyor belt, which is either perforated or inclined transversely so as to allow the particles to be scattered onto the plate located below. In order to assist the scattering, the belt may be vibrated. In an alternative and preferred variant, the first distribution unit (2a) comprises at least one Archimedes'screw extending along a radius of the first plate (1a) in order to transport the particles from the outer periphery to the inner periphery of the first plate (1a). Said at least one Archimedes'screw is contained in an enclosure provided with one or more openings extending downward and along said radius of the first plate (1a) in order to allow the particles to be scattered homogeneously along the radius of the first plate (1a).

In the case of an Archimedes'screw, if the particles to be dried are poured out by the supply unit (9) at one end of the Archimedes'screw of the first distribution unit (1a), which is for example adjacent to the enclosure (10), there is a high risk that the thickness of the layer of particles will decrease along the radius of the first plate (1a) when approaching the center of the plate. Such a thickness gradient (d(da)/dR) is not advisable because it entails a gradient along the radius of the first plate (1a) of intermediate humidity levels (H1a) of the particles after a revolution on the first plate (1a). Even worse, if the layer becomes so thin that holes appear in the layer of particles, this creates regions with low resistance to the hot gas flow, which will preferentially pass through these regions to the detriment of the particles to be dried.

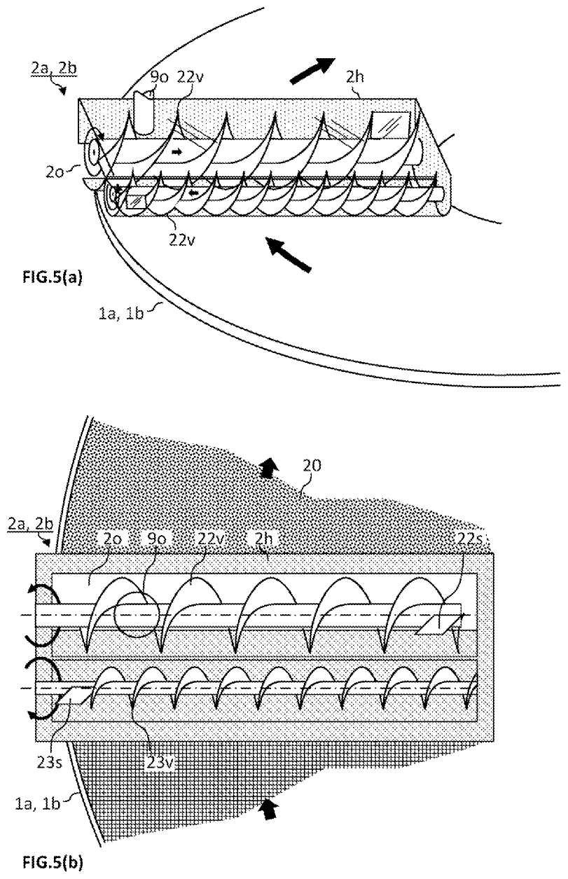

In order to overcome this problem, the first distribution unit (2a) extending along a radius of the first plate (1a) may, as illustrated in FIG. 5(a) and 5(b), comprise a distribution screw (21) and a recirculation screw (22), which are placed side by side and contained in a casing (2h). The casing (2h) comprises a supply opening coupled to an exit (9o) of the supply unit (9). The supply opening is configured to deliver particles coming from the supply unit (9) to one end of the distribution screw (21). For example, the supply opening may be located above the distribution screw (21) in order to allow the particles to fall by gravity into the casing (2h- and be carried by the rotation of the distribution screw (21) in a first sense along the radius of the first plate (1a).

A distribution opening (20) extends along the length of a lower face of the casing (2h), below the distribution screw (21), so that the particles can emerge from the casing (2h) by gravity and fall onto the first plate (1a) along the radius of the latter. In order to prevent the particles from falling mostly into a section adjacent to the supply opening (9o), the distribution screw (21) is only partially separated from the recirculation screw (22), allowing an excess of particles to pass from the distribution screw (21) to the recirculation screw (22), which rotates in a second sense that is opposite to the first sense of rotation of the distribution screw (21) so as to transport the particles unloaded in this way in the direction of the enclosure (10). At the end of the recirculation screw (22) adjacent to the enclosure, the recirculation screw (22) is provided with a vane (22s) which, by rotation of the recirculation screw (22), returns the particles to the distribution screw (21). A similar vane (21s) is arranged at the end of the distribution screw (21) close to the center of the dryer in order to unload the particles located at this end to the recirculation screw (22) without their falling onto the first plate (1a) through the distribution opening (20). A first distribution unit (2a) of this type allows homogeneous distribution of the particles along the radius of the first plate (1a), thus ensuring that the thickness (da) of the layer of particles deposited on the first plate (1a) is radially substantially constant.

The second distribution unit (2b) fulfills the same functions for the second plate (1b) as the first distribution unit (2a) does for the first plate (1a), except that it is not supplied upstream by a supply unit (9) but by the transfer unit (4t) which will be discussed below. It may be different to the first distribution unit (2a), although the first and second distribution units (2a, 2b) are preferably similar, and preferably even identical. The second distribution unit (2b) is preferably of the type discussed above with reference to FIGS. 5(a) and 5(b). Even if they are similar, the first and second distribution units (2a, 2b) do not necessarily need to operate at the same rate, and the layers deposited on the first and second plates (1a, 1b) do not necessarily need to have the same thickness (da, db).

### Structure of the Dryer—1^{st} and 2^{nd} Recovery Units (3a, 3b) and Transfer Unit (4t)

The first recovery unit (3a) of the first plate (1a) makes it possible to recover the particles deposited on the first plate (1a) after a rotational revolution of the latter. The first recovery unit (3a) is therefore positioned upstream of the first distribution unit, adjacent thereto, so that the particles having an initial humidity level (H0a) that are deposited on the first plate by the first distribution unit can perform a rotation, preferably of between 340 and 360°, or preferably between 345° and 355°, before they are collected and removed from the first plate (1a) with an intermediate humidity level (H1a) by the first recovery unit (3a). In order to maximize the angle of rotation of the particles on the first plate (1a) between the first distribution unit (2a) and the first recovery unit (3a), the latter are preferably arranged beside one another or the first distribution unit (2a) may even be arranged above the first recovery unit (3a).

As illustrated in FIG. 6(a) and 6(c), the first recovery unit (3a) preferably comprises at least one Archimedes'screw (32v) extending along a radius of said plates, which is contained in an enclosure (3h) provided with one or more recovery openings (3i) extending along said radius of the corresponding plate. The openings are connected to a scraper (3r) or brush capable of gathering the particles conveyed by the rotation of the first plate (1a) and directing them through the recovery opening (3i) into the casing (3h) of the Archimedes'screw (32v). By rotating, the Archimedes'screw transports the particles collected in this way to a removal opening (30) which is connected to the transfer unit (4t). The first recovery unit (3a) is thus coupled downstream to the transfer unit (4t), which is configured to transfer the particles collected in this way by the first recovery unit (3a) to the second plate (1b).

FIG. 6(b) and 6(d) illustrate another variant of the first recovery unit (3a), which is suitable particularly but not exclusively for cases in which the first plate (1a) comprises a raised circumferential rim that requires the Archimedes'screw (32v) to be raised above this rim. As in the variant of FIG. 6(a) and 6(c), the first recovery unit (3a) in the present variant comprises an Archimedes'screw (32v), the rotation of which makes it possible to radially transport the particles collected along a radius of the first plate (1a) toward the outside of the latter and discharge them to the removal opening (30) connected to the transfer unit (4t). In the present variant, the first recovery unit (3a) furthermore comprises a multi-blade rotor (3s) arranged upstream of and parallel to the Archimedes'screw (32v). The rotation of the multi-blade rotor (3s) makes it possible to supply the Archimedes'screw (32v) even if the latter is raised relative to the surface of the first plate. In all events, the multi-blade rotor (3s) ensures a reproducible and reliable supply of the Archimedes'screw (32v) with particles.

The transfer unit (4t) is coupled upstream to the first recovery unit (3a) of the first plate (1a) and downstream to the second distribution unit (2b) of the second plate (1b). The function of the transfer unit (4t) is therefore to transfer the partially dried particles from the first plate (1a) to the second plate (1b) in order to complete the drying of the particles. The type of transfer unit (4t) for transporting the particles from the first plate (1a) to the second plate (1b) depends on the configuration of the dryer. If the first plate (1a) is the upper plate, the transfer means may be a simple tube that connects the first recovery unit (3a) of the first plate (1a) to the second distribution unit (2b) of the second plate, into which the particles fall by gravity. If the first plate (1a) is the lower plate, however, it is preferable for the transfer unit (4t) to comprise an Archimedes'screw that makes it possible to lift the particles from the lower first plate (1a) to the upper second plate (1b). This configuration of the lower plate forming the first plate (1a) and the upper plate forming the second plate (1b) has the advantage of reducing the suspension of the finest particles, because in this configuration the hot gas flows from the top downward and presses the particles against the respective plates.

The second recovery unit (3b) fulfills the same functions for the second plate (1b) that the first recovery unit (3a) does for the first plate (1a), with the following differences:
the particles collected by the second recovery unit (3b) have a final humidity level (H1b), which must be in the predefined target range (H1b=H1t±ε), after a first rotational revolution on the first plate (1a) and a second rotational revolution on the second plate (1b) while being exposed to a hot gas flow that passes through the second plate (1b) before passing through the first plate (1a),
the second recovery unit (3b) is not coupled downstream to the transfer unit (4t) but is coupled via the recovery opening (30) to a removal system (40), which removes the particles from the dryer.

The second recovery unit (3b) may be different to the first recovery unit (3a), although the first and second recovery units (3a, 3b) are preferably similar, and preferably even identical.

### First and Second Plates (1a, 1b)

The dryer according to the present invention is particularly advantageous because it can be used to dry particles with very different sizes, ranging from very fine particles such as sawdust, fine grains, ceramic, polymer or metal fibers, to relatively coarse particles, such as wood waste, chips, pellets, agricultural waste, corn husks, etc., by rapidly and easily changing the diameter of the orifices of the plates in the following way. The first and second plates (1a, 1b) may thus comprise a rigid self-supporting structure with a high permeability of the grating type, on which a filtering layer comprising openings with a size and density corresponding to the permeability desired according to the type and size of the particles to be dried is placed. The filtering layer may be a perforated metal sheet, a mesh, a grid or a cloth. In order to facilitate the fitting of such a filtering layer, it may be cut into angular sectors that can be placed and fixed side by side directly on the grating or other self-supporting structure with a high permeability. This would be impossible in practice with dryers comprising a belt or perforated plates, which are designed to dry particles with a single type of size.

The sequence in which the first and second plates (1a, 1b) are stacked depends on the applications and preferences. For example, the first plate (1a) may be placed above the second plate (1b) and the hot gas (for example hot air) circulates from the bottom upward. One advantage of this variant is that the transfer of the partially dried particles from the upper first plate (1a) to the lower second plate (1b) by the transfer unit (4t) takes place from the top downward, assisted by gravity; a simple tube that connects the first recovery unit (3a) to the second distribution unit (2b) is sufficient. On the other hand, since the hot gas flow circulates from the bottom upward through the second and first plates, respectively, the particles may lift off and create dust. Slight fluidization of the layer of particles may be advantageous for drying them, but the formation of a cloud of fine dust suspended in air must be avoided. This configuration is therefore most suitable for drying relatively heavy particles that do not readily form a cloud of dust.

For relatively light or relatively fine particles, the first plate (1a) may however be placed below the second plate (1b) and the hot gas thus circulates from the top downward, as represented in FIGS. 1 to 7. In this configuration, the particles are pressed against the plate on which they are located, which compacts the layer of particles and significantly reduces the suspension of dust. Compacting the layer of particles by a hot gas flow from the top downward risks forming temperature and humidity gradients in the thickness of the layer that are greater than in a layer slightly fluidized by a flow of hot gases from the bottom upward. However, the particles that have different temperatures and humidity levels are mixed during the recovery of the particles from the first plate (1a) and their transfer to the second plate (1b) by the transfer unit (4t), which comprises for example an Archimedes'screw. The comingling that takes place in the transfer unit (4t) allows the efficiency of the drying to be increased further by remixing the particles, thus making it possible to deposit a layer of particles with a homogeneous temperature and humidity level over the thickness of the layer.

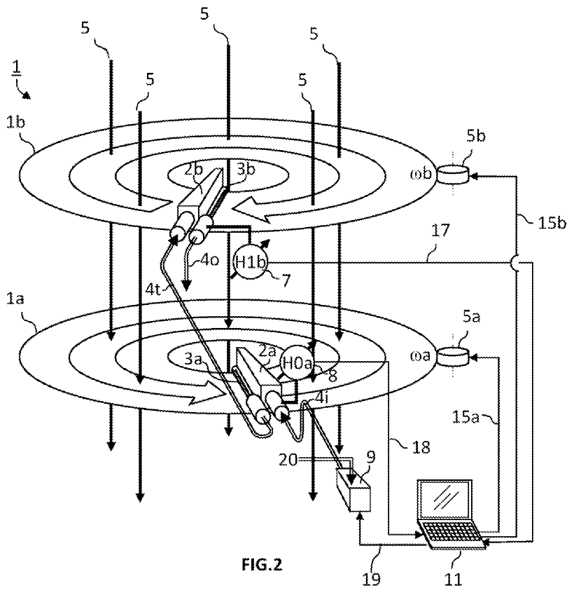

FIGS. 1 and 2 illustrate dryers comprising two plates. In order to reduce the space on the ground occupied by the equipment, it is however quite possible to mount:
at least one third circular plate mounted substantially horizontally at a certain distance and separated from the first plate (1a) by the second plate (1b) so as to rotate about the vertical axis (Z) in the opposite sense of rotation to the second plate, the surface of said plate being perforated and permeable to fluids such as air, water vapor and water, and
a transfer means for transferring the particles gathered from the second plate (1b) by the recovery means (2b) to a third distribution means capable of distributing said particles along a radius of the third plate.

It is clear that as many parallel plates as desired may be mounted so as to rotate about the axis Z according to the requirements of a particular application. However, a dryer that comprises two plates (1a, 1b) is suitable for most applications. The use of a plurality of stacked plates makes it possible to reduce the outer diameter of the plates, but it increases the production cost of the dryer.

The plates (1a, 1b) are contained in an outer enclosure that has a diameter corresponding to the diameter of the plates, with a margin that is sufficient to avoid friction but is as small as possible in order to allow sealing of the interface between the plates and the outer wall. The sealing may be ensured for example by a flexible skirt, which is fixed to the outer wall and rests on a raised rim of the circumference of the plates. In this way, the layer of particles resting on a plate in rotation is not in contact with the static skirt, thus ensuring good sealing and integrity of the layer of particles on the plate. This cannot be done on a belt dryer in which the sealing skirt is placed between the rolling belt and the particles are located on the edges of the belt. There is therefore a fringe of particles in contact with the static skirt on each edge of the belt, which does not move at the same speed as the particles that lie in the middle of the belt.

As illustrated in FIG. 1, the central part of the plates is preferably hollow and contained in an internal shaft (6), which is cylindrical and centered on the axis of rotation (Z). Such a shaft (6) rising over practically the entire height of the dryer, in any case between the upper and lower plates, has numerous advantages that amply compensate for the loss of area available for the drying. Specifically, if the outer diameter of the plates is D1 and the diameter of the cylindrical shaft is D6=n×D1, where n<1, the loss of area available for the drying on each plate between a full plate and a plate comprising a shaft is D6/D1=n2. For example, if the shaft has one third of the diameter of the outer enclosure, the loss of area available for the drying is only 1/9˜11%. A shaft (6) firstly allows easy access for an operator to all the mechanical elements of the machine, such as bearings, reducing gears, jacks, etc. It also facilitates replacement of the flexible porous layers to be deposited and fixed on the grating that provides the plates with their mechanical integrity. The shaft may also be used to accommodate the motors (5a, 5b) that drive the rotation of the plates, as well as the fans used to generate the hot gas flow, with the advantage of a substantial reduction in the sound pollution generated by the dryer. In the case of a gas flow from the top downward, as represented in FIG. 1, windows (6w) at the bottom of the shaft (6), which are located below the lower plate, make it possible to recover the hot gas and remove it upward inside the enclosure. Alternatively, the hot gases may be removed via a space defined in a double wall of the enclosure (10).

Moreover, the shaft (6) makes it possible to fix the first and second distribution units (2a, 2b) and recovery units (3a, 3b) at their two ends in order to avoid the need to fix them cantilevered only on the outer enclosure. This furthermore frees up space at the inner ends of said means lying side by side in order to accommodate their width. Lastly, such a structure makes it possible to rigidify the surface contained between the shaft (6) and the outer enclosure (10), making it possible to maintain good planarity of the plates. This is important for cleaning and recovery of the particles by a scraper or a brush, the latter being efficient only if the surface of the plates is perfectly flat.

Since the size distribution of the particles of a given type may be broad, it is difficult to prevent the finest fraction of the particles from passing through the perforations of the plates and falling onto the lower plate or plates, then onto the floor of the enclosure containing the plates. In order to avoid excessive accumulation of particles on the floor, as well as to recover them, it is advantageous to provide the floor with an extraction opening for extracting the finest particles which have been deposited on the floor. Furthermore, a scraper or brush fixed securely to the lower plate and capable of following the rotational movement of the latter serves to push the particles deposited on the floor toward said removal opening. Since the scraper or brush is fixed to the lower plate, it does not need to be separately motorized.

### Drying Principle

The drying of the particles deposited on the perforated first plate (1a), which are transferred after a given rotation of the first plate to the perforated second plate (1b) in rotation, is performed by a blowing means (5g) for blowing hot gas in a flow which is substantially parallel to the vertical axis (Z) and passes through the second plate (1b) before passing through the first plate (1a), thus defining a counter-current drying system. It is important for the flow of hot, dry gas to pass first through the second plate (1b), where the particles are already partially dried by their time spent on the first plate (1a), which a hot gas flow partially loaded with humidity reaches after passing the second plate (1b).

The particles are distributed onto the first plate with their initial humidity level (H0a). The particles are then carried by the rotation of the first plate (1a) before they are recovered by the first recovery unit (3a) and transferred to the second plate (1b) by the transfer unit (4t). During the rotation of the first plate (1a), the particles are exposed to the hot gas flow leaving the second plate (1b), which is slightly less hot and more humid than the hot gas upstream of the second plate (1b). The humidity factor of the particles located on the first plate (1a) decreases under the action of the hot gas flow as the rotation of the first plate (1a) progresses, until they reach the first recovery unit (3a) with an intermediate humidity level (H1a) that is less than the initial level (H0a) but still greater than the final level (H1b) (which must lie in the predefined target range) (i.e., H1b<H1a<H0a). The particles transferred by the transfer unit (4t) arrive on the second plate (1b) partially dried with the intermediate humidity level (H0b=H1a) and undergo a second rotation, preferably in the opposite sense, during which the hot air flow finishes drying them until they reach their final humidity factor (H1b). The drying remains optimal both on the first plate (1a) and on the second plate (1b) since the gradients of temperature (ΔT) and humidity (ΔH) between the particles and the hot gases remain high on both plates. This is because, with a temperature higher and a humidity level lower than the particles located on the first plate (1a), the particles of the second plate (1b) are exposed to hotter and drier gases than those of the first plate (1a). Nevertheless, although the particles located on the first plate (1a) are exposed to less hot and more humid gases than those of the second plate, since they are more humid and less hot than the particles located on the second plate (1b) the gradients of temperature (ΔT) and humidity (ΔH) between the particles and the hot gases remain high.

Rotation of the first and second plates (1a, 1b) in opposite senses optimizes the drying process. The hot gas, for example hot air or any other gas obtained from a combustion process, follows a path which is opposite to that of the particles. Since the humidity level of the particles located on the second plate depends on their angular position, it follows that the humidity level of the air, which has passed through the second plate (1b) and has extracted some of the humidity of the particles while transferring some of its heat, also depends on the angular position and will be higher where the particles that the flow affects have a higher humidity level, that is to say at low angles of rotation of the second plate (1b). The hot gas downstream of the second plate (1b) is also the upstream gas of the first plate.

FIG. 1 illustrates by way of example humidity levels of the particles according to their position on various angular sectors of the first and second plates (1a, 1b). It can be seen that after having passed through the particles of the second plate (1b) that are adjacent to the second recovery unit (3b), which have the lowest final humidity level (H1b), the column of hot gas reaches the particles freshly deposited on the first plate (1a), which have the highest initial humidity level (H0a). Thus, the first contact of the particles on the first plate with a column of hot gas is very efficient in rapidly removing a large amount of water. As the first plate rotates and the particles lose some of their initial humidity level, the hot gases become moderately loaded with humidity but are sufficiently hot and dry to reduce the humidity level until reaching the intermediate level (H1a) that the particles need to reach before they are transferred to the second plate (1b).

1. A dryer for drying particles having an initial humidity level (H0a) until reaching a final humidity level (H1b) that lies in a predefined target range centered around a target humidity value (H1t) (i.e., H1b=H1t±ε), the dryer comprising,
(a) an enclosure comprising an essentially cylindrical wall extending along a vertical axis (Z)
(b) a first circular plate mounted on the wall of said enclosure, substantially perpendicularly to the vertical axis (Z) and so as to rotate in a first sense about the vertical axis (Z), the rotation of which is actuated by a first motor configured to impart a first speed of rotation (ωa) to the first plate (1a), the surface of the first plate being perforated and permeable to fluids such as air, water vapor and water, and
(c) a second circular plate mounted at a certain distance from the first plate on the wall of said enclosure, substantially perpendicularly to the vertical axis (Z) and so as to rotate about said vertical axis (Z), the rotation of which is actuated by a second motor (5b) configured to impart a second speed of rotation (ωb) to the second plate (1b), with a value different than the first speed of rotation (ωa) of the first plate (1a), the surface of the second plate being perforated and permeable to fluids such as air, water vapor and water,
(d) a first distribution unit for distributing the particles to be dried, which is configured to receive the particles to be dried from a supply unit and to distribute these particles before drying along a radius of the first plate,
(e) a first recovery unit, which is configured to recover the particles deposited on the first plate after a rotation of the latter through a given angle, the first recovery unit being located downstream of, and preferably adjacent to, the first distribution unit,
(f) a transfer unit for transferring the particles gathered from the first plate by the first recovery unit to a second distribution unit, which is configured to distribute said particles along a radius of the second plate,
(g) a second recovery unit for recovering the particles deposited on the second plate after a rotation of the latter through a given angle, the second recovery unit being located downstream of, and preferably adjacent to, the second distribution unit (2b) and being configured to remove the particles from the dryer by a removal system after drying,
(h) a system for blowing hot gas in a flow substantially parallel to the vertical axis (Z), passing first through the perforated surface of the second plate before passing directly after through the perforated surface of the first plate,
characterized in that the dryer furthermore comprises:
(i) an exit sensor (7), which is located at the second recovery unit (3b) or in the removal system (40) and is configured to measure the final humidity level (H1b) of the particles in or leaving the second recovery unit (3b),
(j) a processor (11), which is coupled to the exit sensor (7), to the first and second motors (5a, 5b) and to the supply unit (9) and is configured to optimize the drying parameters, including the speeds of rotation (ωa, ωb) of the first and second plates (1a, 1b) and, optionally, a rate of supply (dma/dt) of the particles by the supply unit (9), in the following way:
extracting the final humidity level values (H1b) of the particles that are measured by the exit sensor (7) in the course of time and comparing them with the target humidity level (H1t),
if the final humidity level values (H1b) do not lie in the predefined target range (H1t±ε), modifying the values of the speeds of rotation (ωa, ωb) of the first and second plates (1a, 1b) and, optionally, a rate of supply (dma/dt) of the particles by the supply unit (9), in order to obtain final humidity level values (H1b) lying in the predefined target range (H1t±ε).

2. The dryer as claimed in claim 1, wherein if the final humidity level values (H1b) are greater than the predefined target range the processor (11) determines theoretical values of one or more of the speeds of rotation (ωa, ωb) and the rate of supply (dma/dt) that make it possible to obtain final humidity level values (H1b) lying in the predefined target range (H1t±ε), and
reduces the first speed of rotation (|ωa|) of the first plate (1a) to the corresponding theoretical value,
reduces the second speed of rotation (|ωb|) of the second plate (1b) to the corresponding theoretical value.

3. The dryer as claimed in claim 1, wherein if the final humidity level values (H1b) are less than the predefined target range the processor (11) determines theoretical values of one or more of the speeds of rotation (ωa, ωb) and the rate of supply (dma/dt) of the particles onto the first plate (1a) that make it possible to obtain final humidity level values (H1b) lying in the predefined target range (H1t±ε), and
increases the first speed of rotation (|ωa|) of the first plate (1a) to the corresponding theoretical value,
increases the second speed of rotation (|ωb|) of the second plate (1b) to the corresponding theoretical value, plate

4. The dryer as claimed in claim 1, comprising an entry sensor (8), which is placed at the supply unit (9) or at the first distribution unit (2a) and is configured to measure an initial humidity level (H0a) of the particles entering the first distribution unit (2a), wherein the processor (11) is configured to optimize the drying parameters only during a period in which the initial humidity level (H0a) has an initial value that is substantially constant and does not vary by more than a predefined reference range (±δ) around a reference value (H0r).

5. The dryer as claimed in claim 4, wherein the supply unit (9) is coupled to a source (20) of particles to be dried, and wherein the processor (11) is configured to attenuate or eliminate time variations of the final humidity level values (H1b) that are due to time variations of the initial humidity level values (H0a) of the particles to be dried, in the following way:
extracting the initial values of the initial humidity levels (H0a) that are measured by the entry sensor (8) in the course of time and comparing whether the initial values continue to lie in the predefined reference range (±δ) around the reference value (H0r)
if the initial values do not lie in the predefined reference range (i.e., H0a≠H0r±δ), modifying the rate of supply (dma/dt) of the particles by the supply unit (9) without modifying the speeds of rotation (ωa, ωb) of the first and second plates (1a, 1b), in order to obtain final humidity level values (H1b) lying in the target range (H1t±δ) even in the event that the initial values (H0a) do not lie in the predefined reference range

6. The dryer as claimed in claim 5, wherein if the initial values of the initial humidity levels (H0a) are less than the reference range the processor (11) is configured to:
determine a theoretical value of the rate of supply (dma/dt) that makes it possible to increase a thickness of a layer of particles distributed by the first distribution unit (2a) onto the first plate (1a), in order to ensure that an intermediate humidity level (H1a) of the particles adjacent to the first recovery unit (3a) lies in an intermediate range and
increase the rate of supply (dma/dt) of the supply unit to the theoretical value.

7. The dryer as claimed in claim 5, wherein if the initial values of the initial humidity levels (H0a) are greater than the reference range, the processor (11) is configured to:
determine a theoretical value of the rate of supply (dma/dt) that makes it possible to reduce a thickness of a layer of particles distributed by the first distribution unit (2a) onto the first plate (1a), in order to ensure that an intermediate humidity level (H1a) of the particles adjacent to the first recovery unit (3a) lies in an intermediate range and
reduce the rate of supply (dma/dt) of the supply unit to the theoretical value.

8. The dryer as claimed in claim 1, wherein the first plate (1a) is located below the second plate (1b), and wherein the hot gas circulates from the top downward

9. The dryer as claimed in claim 1, wherein the second plate (1b) rotates in an opposite sense of rotation to the first plate (1a).

10. The dryer as claimed in claim 1, wherein the first and second plates (1a, 1b) comprise a rigid self-supporting structure with a high permeability of the grating type, on which a filtering layer comprising openings with a size and density corresponding to the permeability desired according to the type and size of the particles to be dried is placed.

11. The dryer as claimed in claim 1, wherein the first and second distribution systems (2a, 2b) for distributing the particles to be dried onto the first and second plates (1a, 1b), respectively, as well as the supply unit (9), each comprise at least one Archimedes'screw extending along a radius of the first and second plates (1a, 1b), respectively, said at least one Archimedes'screw being contained in an enclosure provided with one or more openings extending along said radius of the plates (1a, 1b).

12. The dryer as claimed in claim 1, wherein the first and second recovery units (3a, 3b) each comprise at least one Archimedes'screw extending along a radius of said plate, which is contained in an enclosure provided with one or more openings extending along said radius of the first plate (1a), said openings being connected to a scraper or brush capable of gathering the particles conveyed by the rotation of the plate and directing them toward the Archimedes'screw.

13. The dryer as claimed in claim 1, wherein after the gas has passed through the perforated surface of the first plate (1a), the hot gas blowing system (5):
either is configured to remove the gas from the enclosure, or
comprises an air dryer for capturing the moisture present in the gas before reheating the gas thus dried and recirculating it through the second and first plates (1b, 1a), respectively.

14. The dryer as claimed in claim 13, wherein the vertical axis (Z) is centered in an essentially cylindrical hollow shaft (6), the wall of which extends at least from the first plate (1a) to the last plate (1b, 1c) and comprises one or more openings offering fluidic access to the interior of the shaft (6) for the gas that has passed through the perforated surface of the first plate (1a), and wherein the shaft comprises either:
one or more openings toward the outside of the enclosure, making it possible to remove the gas from the enclosure, or
the dryer and one or more openings configured to recirculate the gas after it has passed through the dryer, in a flow substantially parallel to the axis Z, passing first through the perforated surface of the second plate (1b) before passing directly after through the perforated surface of the first plate (1a).

15. The dryer as claimed in claim 1, wherein the supply unit (9) is connected upstream to a source (20) of said particles to be dried, preferably a silo, said particles preferably comprising sawmill wood waste, construction material wood waste, paper or cardboard waste, food industry products such as cereals, and are in the form of powder, granulates, chips, pellets, cakes, or fragments generally not exceeding 10 cm in length.

16. The dryer as claimed in claim 2, wherein the predefined target range is when H1b>H1t+ε.

17. The dryer as claimed in claim 2, wherein the processor (11) makes it possible to obtain final humidity level values (H1b) lying in the predefined target range (H1t±ε), and further reduces the rate of supply (dma/dt) of particles distributed onto the first plate (1a) to the corresponding theoretical value.

18. The dryer as claimed in claim 3, wherein the predefined target range is H1b<H1t±ε).

19. The dryer as claimed in claim 3, wherein the processor (11) makes it possible to obtain final humidity level values (H1b) lying in the predefined target range (H1t±ε), and further increases the rate of supply (dma/dt) of particles distributed onto the first plate (1a) to the corresponding theoretical value.

20. The dryer as claimed in claim 4, wherein the reference value (H0r) is defined by H0a=H0r±δ.
